(19) United States
(12) Patent Application Publication
(10) Pub. No.: US 2022/0268921 A1
(43) Pub. Date: Aug. 25, 2022

(54) Electrically Scanned Surface Imaging Radar

(71) Applicants: John Lovberg, San Diego, CA (US); Vladimir Kolinko, San Diego, CA (US)

(72) Inventors: John Lovberg, San Diego, CA (US); Vladimir Kolinko, San Diego, CA (US)

(21) Appl. No.: 17/185,056

(22) Filed: Feb. 25, 2021

(51) Int. Cl. G01S 13/90

(52) U.S. Cl. CPC G01S 13/9011; G01S 13/9027; G01S 13/9056

(57) ABSTRACT

A frequency-modulated continuous wave (FMCW) millimeter-wave (MMW) radar system. Preferred embodiments operate within a frequency range between about 77 and 81 GHz (wavelengths between about 3.846 mm and 3.304 mm). The MMW frequency in these embodiments is increased or decreased (“chirped ”) in a very linear fashion over some or all of this operating frequency range. Over the chirp period, the time derivative of the transmit frequency, df/dt, is held constant. In the time τ it takes for the radar's transmit signal, moving at the speed of light c, to travel from the antenna to a target at a range R and return back to the antenna (τ=2R/c), the transmitter's output frequency will have moved by an amount (df/dt)*τ. Thus, the more distant the reflecting target, the greater the two-way signal time of flight and consequently the greater the frequency change. By mixing the delayed returning signal with the current transmitter output signal, this difference frequency is measured directly, determining uniquely the distance from the radar to the reflecting target.

### FIELD OF THE INVENTION

The present invention relates to systems used for detection of foreign object debris (FOD) at airports from a moving vehicle.

### BACKGROUND OF THE INVENTION

Detection and removal of FOD on airport surfaces is critical to the safety of air travel and also has a significant impact on the cost of flight, due to the high cost of aircraft engine repair and replacement resulting from damage due to FOD ingestion. FOD detection technology, including radar and optical surveillance systems, has been available for some time, but has not been widely adopted due to its high cost of installation, operation and maintenance. Applicant's employer. Trex Enterprises Corporation, built some of the world's first radar-based FOD detection equipment; including a vehicular-mounted short-range mobile millimeter-wave imaging radar system described in prior art U.S. Pat. No. 8,362,946. This radar system has proven effective in FOD detection and removal operations, but its size, weight and cost still exceed thresholds that would encourage widespread adoption of the technology. What is needed is FOD detection radar with substantially reduced size, weight and cost, without compromise to debris detection performance.

Over the past 25 year, the applicants' employer, Trex Enterprises Corporation, has developed a wide array of millimeter-wave communication and millimeter-wave imaging (both passive and active) systems. Trex's millimeter-wave patents in these technologies include the following:

Trex Millimeter-Wave Imaging Patents

| Patent Number | Issue Date |
|---|---|
| 8,362,946 | Jan. 29, 2013 |
| 8,362,948 | Jan. 29, 2013 |
| 7,948,428 | May 24, 2011 |
| 7,782,251 | Aug. 24, 2010 |
| 7,692,571 | Apr. 06, 2010 |
| 7,019,683 | Mar. 28, 2006 |
| 6,943,182 | Aug. 30, 2005 |

FOD Finder Pat. No. 8, 362

Prior an U.S. Pat. No. 8,362,946 describes a short-range mobile millimeter-wave imaging radar system. The teachings of this patent are hereby incorporated herein by reference, and are briefly summarized as follows:

The radar system is mounted on a vehicle as shewn in FIG. 1A which is a copy of FIG. 10 from the above '946 patent and is designed to detect objects in or near the path of the vehicle. The system includes electronics adapted to produce millimeter wave radiation scanned over a frequency range of a few gigahertz. The scanned millimeter wave radiation is broadcast through a frequency scanned transmit antenna to produce a narrow transmit beam scanning electronically in a vertical direction; thus defining a narrow, approximately one-dimensional electronically scanned field of view covering the vertical angular range scanned by the span of millimeter wave frequencies. The transmit antenna is mechanically pivoted and rotated in a direction perpendicular to the frequency-scanned direct on (such as the azimuth direction) so as to combine with the frequency scanning to define a 2-dimensional field of view. Reflected millimeter wave radiation is collected by a receive frequency scanned antenna approximately co-located with the transmit antenna and adapted to produce a narrow receive beam approximately co-directed in the same directions as the transit beam, with approximately the same field of view. Computer processor equipment compares the intensity and frequency content of the received millimeter-wave signals for a pre-determined set of ranges and known directions of the transmit and receive beams to produce a radar image of a desired portion of the field of view. The system described in the '946 patent includes a GPS position tracking system, inertial navigation unit, automatically controlled video camera for visual object identification and computerized object logging and labeling system. The radar system operates in the millimeter wave frequency range between 78 and 81 GHz.

A millimeter wave (MMW) frequency source is swept linearly between 78 and 81 GHz and fed to the transmit antenna to produce the frequency-scanned transmit beam. The receive beam is similar to that of the transmit beam and is co-aligned with the transmit beam at every given time to maximize the strength of signals received by reflections of transmitted radiation off of ground objects. The receive signal is downconverted to low frequencies by way of mixing with the transmit signal, at which point it is digitized and analyzed spectrally using a digital Fast Fourier Transform (FFT) processor. As the transmitter and receiver beams are frequency-scanned in elevation, a computer creates two-dimensional images (range and elevation) of the target environment, and these are stitched together to create a 3-D image as the antennas are swept in azimuth. Radar energy is mostly reflected in the forward direction, away from the radar receiver, when the airport surface is flat and mirror-like. In contrast, foreign objects lying on a runway reflect radiation back toward the radar receiver, and the lack of other significant surface clutter allows for detection of even very minute debris. Distance to the targets is determined based on measurement of the difference in frequency between the transmitted and received beams at any given instant; or in other words the intermediate frequency corresponding to the product of the chirping frequency slope (kHz/μs) and the two-way travel time of the reflected signal (μs). The location of detected runway debris is displayed on a monitor to represent a map of the debris locations on the runway. This prior art patent also describes an integrated hardware/software system with external and internal visible light image recording in addition to the radar imaging equipment. The system also includes Internet database reporting via wireless transmission and the entire system is mobile and integrated to find debris on airport surfaces. The linear frequency ramp determines the range resolution for the radar system and also sweeps the antenna beam in elevation. Having this unique steering capability in two dimensions allows the radar to be vehicle-mounted and driven at high rates of speed, in this instance on an airport runway, while providing ample scan coverage for reliable and effective foreign object debits detection. The radar system described in the '946 patent is extremely successful in detecting and locating debris on airport runways and can detect objects as small as a AAA-battery from a distance of over 100 meters. However, it is very expensive and also quite heavy, with a volume of about 1 cubic meter, and can only be used at low drive speeds due to the slow mechanical scan of the radar. What is needed is a low-cost, small volume, energy efficient radar with a high update rate and no moving parts, suitable for use on smaller vehicles and platforms.

### CMOS Radio Frequency Radar Integrated Circuits

Until recently radar applications typically utilized discrete component in transmit and receive circuitry. Recently, however, complementary metal oxide simi-conductor components have been utilized on integrated circuit chips which include most of the radar component in tiny packages to provide radar systems at a dramatically smaller cost fraction of earlier radar systems. These radar systems are currently being mass produced for, especially, the collision avoidance equipment in the motor vehicle market. These integrated circuit chips typically include a voltage-controlled oscillator that generates a frequency modulated continuous wave signal called a “chirp”. The circuits may also include a closed loop frequency synthesizer, wide frequency band intermediate frequency analog circuits, digital signal sampling and processing baseband circuits, high speed and precision clocks and system control circuitry in a single die. A good example of these sensors is the AWR 1243 Sensor operating at 76-81 GHz radar front end, available from Texas Instruments at TI.com. FIG. 16 is a block diagram of the AWR 1243 Sensor. This product includes three transmit chains, each including variable gain amplifier with a single ended amplifier for direct input into an antenna and four receive chains each including a low noise amplifier and a two quadrature (IQ) baseband output receive channels with a 15 MHz frequency bandwidth. Continuous-time sigma-delta ADCs digitize the receive signals, and the digital front end provides discrimination and signal conditioning. A clock subsystem generates a fast-chirp FMCW waveform at one-fourth of the RF MMW frequency in a closed loop fractional-N PLL. Synchronization signals are provided to bypass the synthesizer in order to cascade multiple AWR 1243 sensors. The sensor includes an internal processor for control and calibration, a ramp generator for flexible real-time operation and associated peripheral and interfaces. The ramp generator provides flexible chirp generation that can be pre-configured eliminating any need for real time control within the active radar operation period. The AWR 1243 Sensor includes a primary data interface over CS12, a common camera interface to connect an external digital signal processor (DSP). AWR 1243 devices can be cascaded to create multi-chip radar systems where one sensor performs as master sensor synchronizing other sensors performing as slaves. Each sensor includes a 20-GHz signal that the slaves receive and use as oscillators for radar sampling. Instructions with the processor provide that using Multiple-Input and Multiple-Output (MIMO) antennas with a single master AWR 1243 and three slaves can operate up to 192 element virtual antennas capable of forming beams with approximately 1-degree angular resolution in azimuth at the MMW frequencies in the 77-81 GHz range. Detail information regarding the TI AWR 1243 sensor is provided by reference in “AWRx Cascaded Radar RF Evaluation Module (MMWCAS-RF-EVM) User's Guide (Rev. A) and other TI online technical documentation.

What is needed in a radar system that can utilize very low-cost CMOS radio frequency radar integrated circuits to detect targets on flat surfaces such as airport runways

### SUMMARY OF THE INVENTION

The present invention is a frequency-modulated continuous wave (FMCW) millimeter-wave (MMW) radar system. Preferred embodiments operate within a frequency range between about 77 and 81 GHz (wavelengths between about 3.846 mm and 3.304 mm). The MMW frequency in these embodiments is increased or decreased (“chirped”) in a very linear fashion over some or all of this operating frequency range. Over the chirp period, the time derivative of the transmit frequency, df/dt, is held constant. In the time τ it takes for the radar's transmit signal, moving at the speed of light c, to travel from the antenna to a target at a range R and return back to the antenna (τ=2R/c), the transmitter's output frequency will have moved by an amount (df/dt)*τ. Thus, the more distant the reflecting target, the greater the two-way signal time of flight and consequently the greater the frequency change between current transmitter output and delayed receive signals. By mixing the delayed returning signal with the current transmitter output signal, this difference frequency is measured to determine the distance front the radar to the reflecting target.

Prior art describes FMCW radar scanning a wide azimuth field by means of a rotary table on which the radar is mounted. This rotary table is heavy and expensive, and the need for mechanical scanning limits the update rate for debris detection to less than 0.25 Hz. This disclosure teaches a new phased array FOD radar architecture which eliminates the need for any moving parts, thereby reducing radar size, weight and cost, at the same time increasing the detection update rate by two orders of magnitude.

In preferred embodiments, the phased array radar has a wide field of view in azimuth, for instance 120 degrees, and a narrower field of view in elevation, for instance about 4 degrees. Over this field of view the radar can detect a wide range of objects, including debris objects lying on airport surfaces. Location of detected objects can be displayed in four dimensions; range (distance from radar), horizontal direction (azimuth), vertical direction (elevation), and closing speed. Embodiments are effective in all environments including clear weather, fog, snow, dust and smoke, during the daytime or in the dark of night. A visible-light and/or infrared camera image can also be combined with the radar image and displayed to the vehicle operator.

Specifically embodiments of the present invention are low-cost, light weight frequency-modulated continuous wave millimeter-wave radar systems that include a frequency scanned millimeter wave radar adapted to produce millimeter wave radiation scanned over a frequency range defining a first end of the frequency range to a second end of the frequency range; and a MIMO millimeter wave antenna system adapted to transmit millimeter wave radiation to a field of view and to receive millimeter wave reflections from objects located in the field of view defining transmit beams and a receive beams, said MIMO millimeter wave antenna comprising a plurality of transmitter channels and a plurality of receive channels mated to discrete antenna elements to permit digital aperture synthesis so as to produce transmitter—receiver pairs at unique spacing intervals in order to permit determination of directions of arrival of millimeter wave radiation reflected from the objects in the field of view. The embodiments also include electronics adapted to modulate the millimeter wave radiation to produce a linear or approximately linear chirped transmit radar beam from one end of the frequency range to the other end operating frequency range, and at least two electronic mixers adapted to mix transmit beams with receive beams in order to directly measure a difference frequency permitting unique determinations of distances to reflecting object in the field of view.

In other embodiment the MIMO antenna system also comprises electronics adapted to modulate the transmit beam to transmit successive chirp sequences from each of the separate transmit channels with a unique pseudo-random code in the form of bi-phase modulation and in some of these embodiments, the codes are orthogonal pseudo random noise codes and these codes may be the orthogonal pseudo random noise codes such as APAS codes.

In some preferred embodiments the field of view is at least 60 degrees in the azimuth direction and the vertical field of view is at least 15 degrees. In some embodiment the first end of the frequency range is from 77 GHz and the second end of the frequency range is 81 GHz. And in some embodiments the radar may be designed for use on military equipment to permit operation in degraded visual environments, and in other embodiments the radar system could designed for use on passenger cars and trucks especially to detect objects on streets, roads and highways. In some embodiments the radar front ends may be provided CMOS integrated circuits at least one integrated circuit board. These radar front ends could be a plurality of Texas Instrument AWR 1243 or other similar sensors.

### BRIEF DESCRIPTION OF THE DRAWINGS

FIG. 1A is a copy of FIG. 10 from U.S. Pat. No. 8,362,946, showing a prior an radar mounted on a ground vehicle to detect foreign object debris (FOD) on airport surfaces.

FIG. 1B is a drawing of compact radar with no moving parts, also mounted on a ground vehicle to detect FOD on airport surfaces.

FIG. 2 is a drawing of a prototype MIMO antenna configuration built and tested by Applicants.

FIG. 3 shows a synthesized antenna aperture with gaps corresponding to the Multiple Input, Multiple Output (MIMO) antenna configuration shown in FIG. 2.

FIG. 4 shows a fully filled synthesized antenna aperture without gaps corresponding to the MIMO antenna configuration including x4 each extra Tx and Rx elements shown in FIG. 7.

FIG. 5A shows a tilled array antenna pattern fora central beam.

FIG. 5B shows the prototype antenna pattern fora MIMO synthetic array with a number of array gaps, for a central beam.

FIG. 5C shows a filled array antenna pattern for a beam at the edge of a 120° azimuth field of view.

FIG. 5D shows the prototype antenna pattern for a MIMO synthetic array with a number of array gaps, for a beam at the edge of a 120° azimuth field of view.

FIG. 6A shows an end-fed microstrip patch array antenna for generating electronically-scanned MMW radiation with vertical polarization.

FIG. 6B shows an end-fed microstrip periodic structure antenna for generating frequency-scanned MMW radiation with horizontal polarization.

FIG. 7 shows a MIMO antenna configuration, modified from that of FIG. 2, to eliminate central array gaps.

FIG. 8A shows processed radar returns from a first prototype of a prototype radar embodiment.

FIG. 8B shows the Graphical User Interface used to display the location of debris objects detected by the radar.

FIG. 9 shows a concept of 3D data cube generated by the prototype embodiment of the present invention.

FIG. 10 shows cross-section of the 3D data cube at a fixed range and illustrates distribution of the data bins representing targets stationary with respect to the ground.

FIG. 11 illustrates transformed 3D data cube such that rite data representing stationary targets is in the same plane at all range bins, which allows to reduce 3D cube to 2D planar data set.

FIG. 12 shows repeating patterns of measured phase shifts in the virtual receiver channels.

FIG. 13 is the block diagram of the radar self-calibration process.

FIG. 14 shows a prototype implementation of the prototype embodiment of the present invention.

FIG. 15 is the prior an example of the Texas Instruments multi-chip integrated circuit board utilized in the prototype embodiment of the present invention.

FIG. 16 is a block diagram of a Texas Instruments AWR 1243 Radar Sensor utilized in embodiments of the present invention.

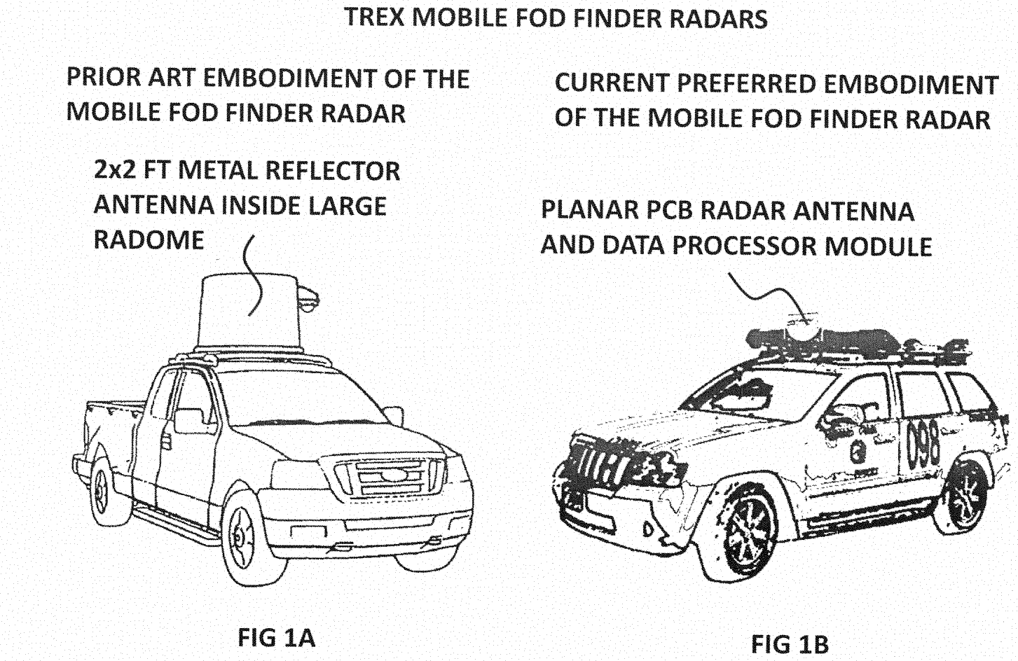

### DETAILED DESCRIPTION OF PREFERRED EMBODIMENTS

### Compact Low-Cost FMCW MMW Radar for FOD Detection

Embodiments of the present invention include a compact frequency-modulated continuous-wave (FMCW) millimeter-wave (MMW) radar system with no moving parts, with an operating frequency in the range of 77 to 81 GHz, used for airport FOD detection from a moving vehicle.

### Range Resolution

In a prototype embodiment actually built and tested by Applicants, the MMW transmitter frequency is chirped very linearly over a frequency bandwidth of 750 MHz (e.g. 78.00 to 78.75 GHz) in 50 microseconds (μs). At this sweep rate (df/dt=15 MHz/μs), the frequency difference measured by mixing the delayed radar return with the present transmit signal is (2/c)*(df/dt)=100 kHz per meter of target range. [Here c is the speed of light.] At a maximum FOD detection range of 200 m, the maximum frequency difference measured by the radar is 20 MHz.

In this preferred embodiment, the delayed radar return is mixed with the current transmit frequency in two separate mixing channels: one in which the transmitter signal is mixed directly (the in-phase, or “I” channel), and the other in which the transmitter signal is shifted backward in phase by 90° prior to mixing (the quadrature-phase, or “Q” channel). This I/Q mixing allows for unambiguous determination of the instantaneous phase of the return signal difference waveform, as well as the frequency difference itself. Digitizers on both the I and Q channels sample the return signal at 20 Msps, matching the maximum difference frequency to eliminate sampling-related frequency ambiguities.

In the preferred embodiment, the digitized waveforms on both the I and Q channels are analyzed by a Fast Fourier Transform (FFT) algorithm, which determines the spectral content of each waveform in terms of relative amplitude and phase. A total of 968 time samples (968 samples/20×10⁶ samples/s=48.4 μs) are collected in each of the I and Q channels, and each set is zero-padded with 28 extra zeroes on each end, to create 1024-point waveforms for complex FFT processing. These waveforms are biased using a standard Hamming window before FFT processing to eliminate numerical processing artifacts. At the FFT output, the complex radar return is dissected into signal amplitude and phase at each of 1024 frequency bins corresponding to (968+56) 1024 range bins between 0 and 200 meters. The approximate size of each range bin (radar range resolution) is c/2B=20 cm. [Here B is the chirp bandwidth].

### Velocity Resolution

Relative motion of the radar and the targets impose a shift in I/Q phase between one sample period (chirp) and the next. Consequently, the progression of the phase at each bin of the range HPT can be tracked across chirps to determine the speed at which any target in that range bin is seen to be moving. The time interval between the start of one chirp and the next must be short compared to the time it takes the distance between the radar and the reflecting target to change by a single radar wavelength; otherwise that the amount of phase changed measured between chirps is ambiguous to some integer number of phase rotations. For a FOD radar mounted atop a truck moving at a speed of 60 mph, for instance, a fixed debris object directly in front of the vehicle will appear to move closer to the radar by one wavelength in two-way path (3.7 mm) in 69 μs. Any chirp repetition interval shorter than 65 μs, then, is more than adequate to measure the closing speed of all fixed debris targets without ambiguity. In preferred embodiments the repetition rate is 50 micro-seconds

The resolution of the object velocity measurements is a function of the total amount of time that tire target phase is tracked. In a preferred embodiment target object phases are tracked for 100 successive chirps at 60 μs intervals, resulting in velocity resolution of about 0.3 meters per second, or about 0.7 mph. The I/Q phase in each range bin, measured for 100 successive chirps, constitutes a separate FFT sample of 100 points for that range bin; these are zero-padded with 14 extra zeroes on each end, biased with a Hamming window, and processed to discriminate 128 velocity bins at a granularity of about 0.55 mph/bin. In the case of a truck moving at 60 mph, then, stationary objects on the ground directly ahead of the radar will generate strongest returns in or around velocity bin 109 (since 60/0.55=109). while stationary objects 60° left or right of center will create peaks in or around velocity bin 55 (since 60*COS(60°)/0.55=55).

### Elevation Resolution

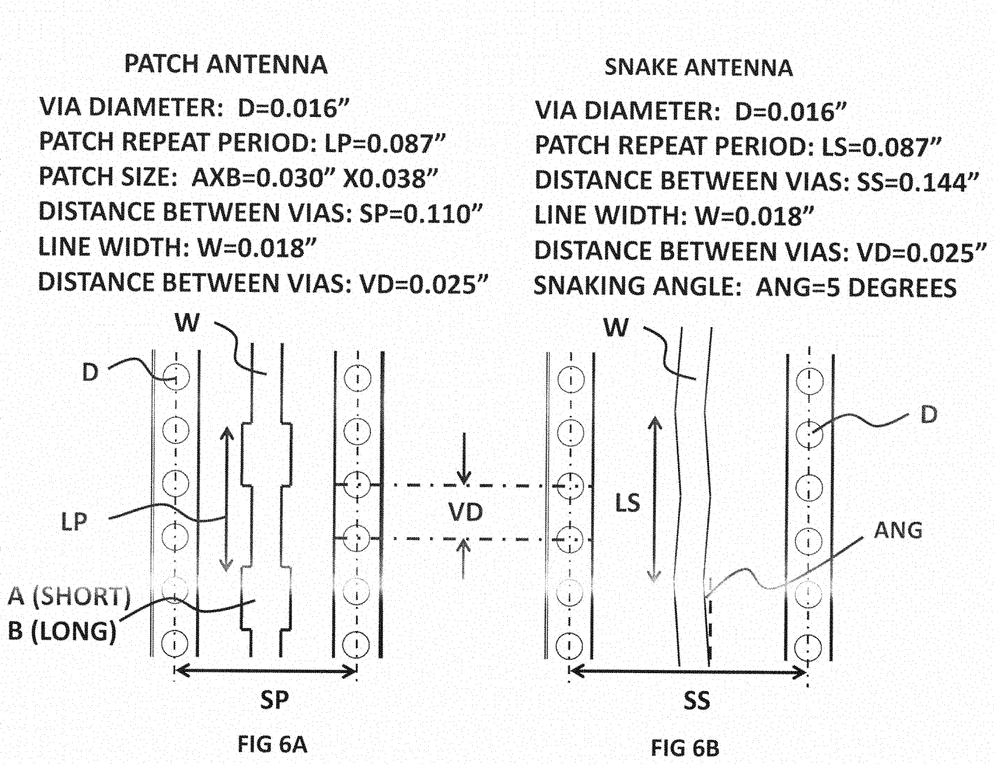

In the preferred embodiment, the transmit and receive antennas are made up or end-fed microstrip patch array or other periodic structure antenna elements that radiate broadly in azimuth (˜120° beamwidth) and narrowly in elevation (˜1° beamwidth). Elevation beam direction varies with signal frequency, scanning a range of ˜4° in elevation as the radar transmit signal frequency varies between 78 and 81 GHz. Microstrip antenna elements of about 8″ length on 0.01″ thick Duroid 3003 dielectric substrate generate the desired azimuth and elevation beamwidths. Radiating elements, such as patches, are spaced at 0.087″ along the microstrip length, or another periodic structure of similar pitch along the antenna propagation direction, generates a beam that steers between 70° and 3° below broadside (perpendicular) as the transmit frequency is ramped from 78 to 81 GHz. Depending on the type of the radiating elements the antenna can be configured to produce radiation polarized in cither vertical or horizontal planes; examples of such elements are shown in FIG. 6A and FIG. 6B.

### Azimuth Resolution

In a preferred embodiment of a low-cost, compact FOD detection radar, target azimuth is determined using a synthetic phased array receiver and a matching Angle-of-Arrival (digital beamforming) algorithm. Separate arrays of transmit and receive antennas are configured in a MIMO array architecture such that differences in instantaneous phase of signals returning from two-way transits between each transmit antenna, a specific target object, and each receive antenna can be compared to infer the angle that the target makes with the antenna normal. Since the radar elevation angle is instantaneously narrow, this measured angle of arrival constitutes the azimuth angle of the radar return along a cone beam pattern emanating from each end fed antenna element.

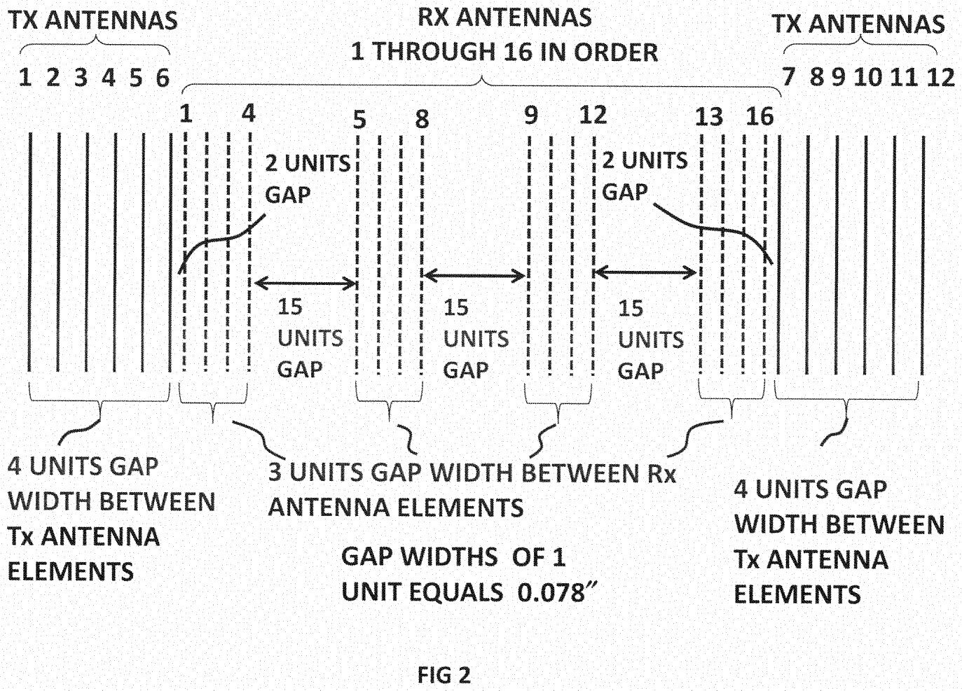

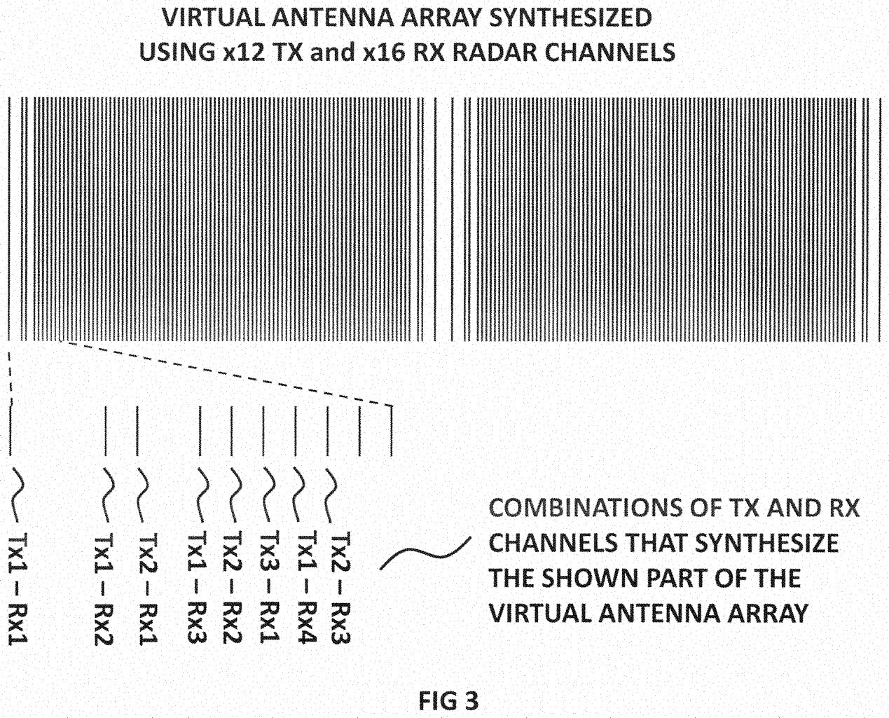

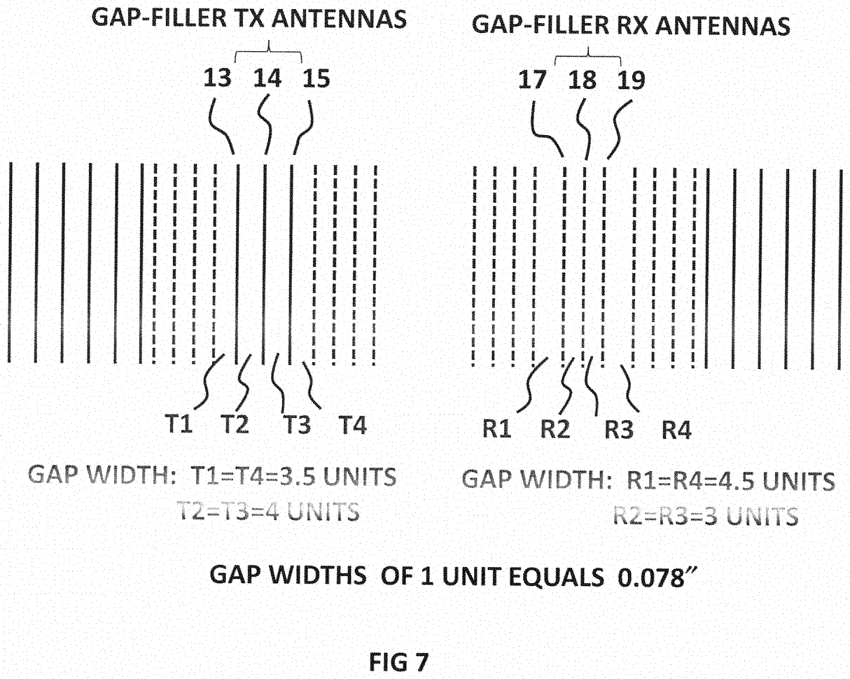

Transmitter arrays (with 3 antennas each per TI radar chip) and receiver arrays (with 4 antennas each per TI radar chip) are laid out so as to create, a non-redundant set of two-way transit path lengths. To the degree possible, the array measures a linear progression of path lengths from shortest to longest, at equal length intervals and with no gaps in the linear sequence, in the prototype embodiment, an array of 12 transmitter arrays and 16 receiver arrays were laid out so as to produce 192 (or 12×16) non-redundant baselines over a total of 206 periodic path-length intervals (with 15 gaps in the array element sequence). FIG. 2 shows the antenna layout in the preferred embodiment and FIG. 3 shows the corresponding synthesized virtual receive antenna. FIG. 7 shows a preferred embodiment with a filled transmitter array which utilizes 15 transmitter arrays and 19 receiver arrays providing 285 baselines (with a total of 121 antennas) which provides much better performance as compared to the prototype.

### MIMO Antenna

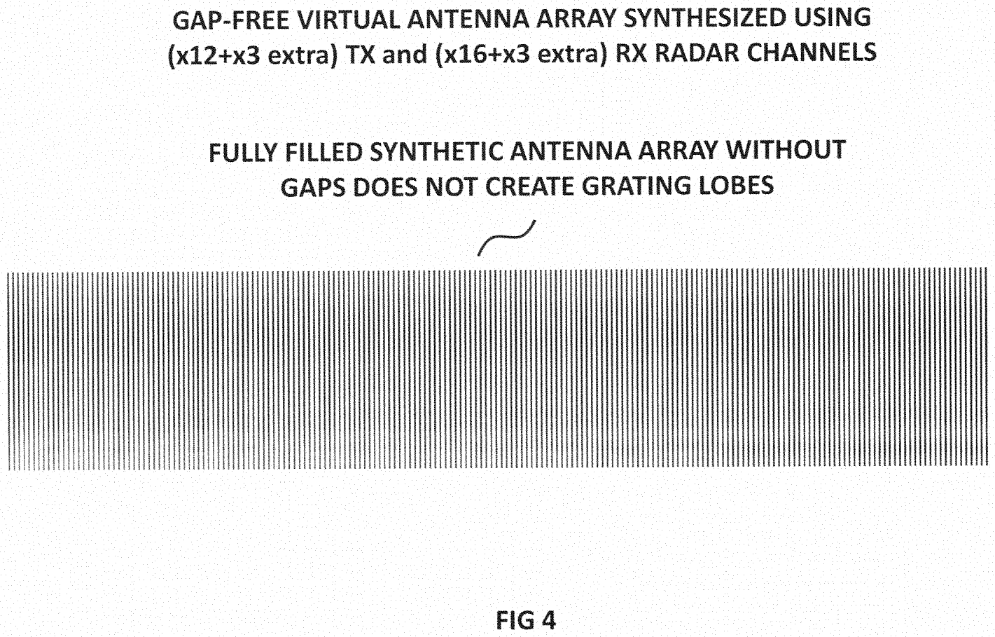

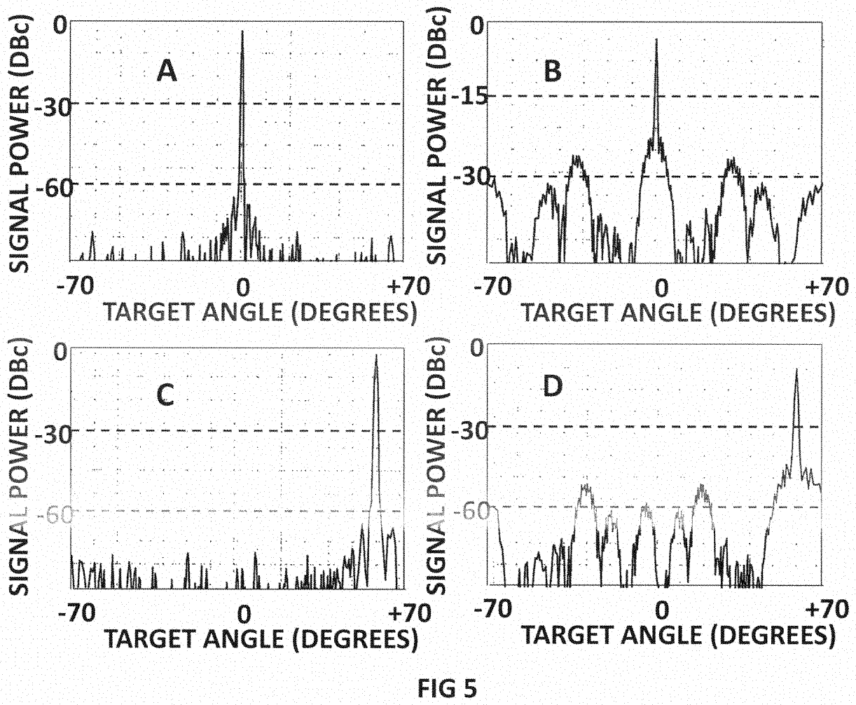

In this prototype environment, in order to cover an azimuth field of view of 120° (±60° from center) without ambiguity in angle of arrival, virtual array elements must be populated at a spacing interval s≤λ/(1+sin(60°)), where λ is the shortest wavelength of transmitted millimeter-wave signals; for instance a suitable spacing interval is 0.078″. This spacing value is referred in later as a “unit”. In this prototype embodiment, physical transmitter elements are placed at 4 times this interval, and physical receiver elements at 3 times this interval, as shown in FIG. 2. This first preferred embodiment antenna layout separates physical antenna elements by a distance sufficient to minimize their crosstalk. For a target left of the antenna, the shortest two-way path between transmitter, target and receiver begins at the leftmost transmitter element and ends at the leftmost receiver element. The longest two way path likewise begins at the rightmost transmitter element and ends at the rightmost receiver element. All path lengths in-between these longest and shortest paths are different, and all vary according to a linear series at intervals of 0.078″, with only a few gaps. FIG. 3 shows the synthesized antenna aperture, with 192 virtual receiving antenna elements ordered and placed such that radiation transmitted from a point at the aperture center returns from a distant target with the same linear path length progression as the transmit-receive pairs in the physical array shown in FIG. 2. Signals detected for the virtual receiving elements are ordered as shown and a digital Fourier transform is computed to produce an intensity map of the radar signal return across azimuth angles as shown in FIG. 5A, FIG. 5B, FIG. 5C and FIG. 5D. Gaps in the virtual array yield some degradation in digital beamforming, shown in FIG. 5B and FIG. 5D, relative to a perfectly filled array. Well known numerical data gap-filling algorithms can mitigate this degradation by approximating the more ideal patterns such as shown in FIG. 5A and FIG. 5C, but have limitations due to the noise. More reliable antenna performance is achieved by adding more antennas to fill the gaps in the virual antenna array. FIG. 4 shows a fully filled, gap-free virtual array antenna aperture synthesized by adding x3 Tx and x3 Rx antennas to the antenna layout by comparing FIG. 2 and FIG. 7. Digital beamforming by way of digital Fourier transform across the 192 virtual receivers in this preferred embodiment results in target azimuth resolution of approximately 0.5° near the center of the field of view, and approximately 1.0° at the edges.

### Coded Sequence Transmission

A straightforward and logical way of measuring the radar phase progression across the 192 transmitter-receiver pairs (“virtual receivers” or VRs) is to activate the twelve transmitters one at a time in succession and measure signal returning from the lone active transmitter in all 16 receivers before progressing to the next transmitter. This technique is not tractable for a phased array radar moving at 60 mph on a vehicular platform, however, since there is not sufficient time to collect 12 sequential measurement sets during the short time it takes for the radar to advance by one wavelength in space. An alternate technique, used in both embodiment to resolve this issue, is to instead transmit from all 12 transmitters simultaneously while imposing a fingerprint, in the form of a unique binary “code” (polarity bits), on the sequence of chirps emanating from each transmitter. The use of a fully orthogonal code set allows that the return signal from each receiver can be decoded, “after the fact,” into separate components corresponding to radiation originating from each individual transmitter. A preferred implementation of this coding technique is through the use a cyclic code sequence from a family of Almost Perfect Autocorrelation Sequence (APAS) codes, for which the autocorrelation function of a code of length N (elements) is identically zero for all values of code offset other than zero and N/2. APAS codes exist at a variety of code sequence lengths. Longer codes produce higher velocity resolution but lower radar update rate; the preferred embodiment uses a code length of 100 bits, or “chips” in standard lexicon. Although isolation of transmit signals with the APAS encoding degrades when the radar is moving, the radar in static state can take full advantages of the codes perfect orthogonality.

One example of a 100-chip APAS sequence is as follows:

−1, −1, +1, −1, −1, +1, +1, +1, +1, +1, +1, +1, +1, +1, −1, −1, −1, +1,
−1, −1, +1, +1, −1, +1, −1, −1, +1, +1, +1, +1, −1, −1, +1, +1, +1, −1,
+1, +1, −1, +1, −1, +1, −1, +1, −1, +1, +1, −1, −1, −1 −1, +1, −1, +1,
+1, −1, −1, −1, −1, −1, −1, −1, −1, −1, +1, +1, +1, −1, +1, +1, −1, −1,
+1, −1, +1, +1, −1, −1, −1, −1, +1, +1, −1, −1, −1, +1, −1, −1, +1, −1,
+1, −1, +1, −1, +1, −1, −1, +1, +1, +1

Using this code as an example, successive chirps from a single transmitter (e.g., “Transmitter I”) are modulated using shown sequence, e.g. inverted polarity for chirp 1, inverted polarity for chirp 2, non-inverted polarity for chirp 3, and so on for a series of 100 sequential chirps. Chirps from a second transmitter are modulated at the same time using the same APAS sequence, but offset in a cyclic pattern, for instance starting at chip 5 (inverted), followed by chip 6 (non-inverted), chip 7 (non-inverted) and so on. Once this sequence reaches the end of the code it starts back at the beginning, ending with the last of the 100 sequential chirps being modulated by chip 4 (inverted). All twelve transmitters are modulated this way, using unique offsets of the same cyclic 100-chip APAS axle, with the caveat that none of the offsets are by 0 or 50 chips relative to any other.

After the range-processed FFTs of 100 successive chirps are assembled from a given receiver in preparation for velocity processing (as described previously under “Velocity Resolution”), the I/Q phases appearing in sequential range bins are decoded using the same APAS code sequence prior to Fourier transforming. Continuing the example above, when the 100 I/Q phases are decoded using the 100-chip APAS code as listed above (without any offset), the velocity transform yields a result corresponding only to the signal received from target illumination by Transmitter I. When the same set of 100 I/Q phases is instead decoded using the APAS code offset to begin at chip 5, the velocity transform yields a result corresponding only to the signal received from illumination by Transmitter 2. This process is repeated for all 12 transmitters, in all 1024 range bins, for all 16 receivers, to create a data cube of 1024 range bins by 128 velocity bins by 192 virtual receivers Digital beamforming across the virtual receiver dimension (with or without gap filling), by way of the digital Fourier transform, yields the final data cube of 1024 range bins by 128 velocity bins by 256 azimuth bins.

### Frequency-Scanned Elevation

A unique feature or the present invention is its ability to resolve a third spatial dimension, in addition to range and azimuth angle. This innovation makes use of the frequency-scanning nature of the lengthwise periodicity of the MIMO antenna elements, for which the radar beam direction changes with large steps (≥800 MHz) in the radar transmit frequency.

The frequency-scanned antenna elements are comprised of linear arrays of radiators fed from one end by a signal propagating along the element from end to end. When individual radiators (patches or other periodic discontinuities) are spaced along the propagating direction at integer intervals of the signal wavelength, the signal phase seen at each of the radiators is identical. This results in a wave being emitted from the antenna element in a plane normal to the element itself, if the wavelength of the propagating signal deviates from this specific value, however, the wave phase between radiators is retarded or advanced accordingly, and the antenna beam direction slants away from perpendicular, in order to compensate the difference. In this way, the antenna scans its beam up and down, along the propagating signal direction, according to the frequency of its transmission. FIG. 6A shows a linear, end-fed microstrip patch array as a preferred embodiment of an antenna producing vertically-polarized radiation. FIG. 6B shows an end-fed microstrip periodic structure antenna as a preferred embodiment of an antenna producing horizontally-polarized radiation. Horizontal polarization is known to improve surface clutter rejection, but dual and cross-polarized architectures are also desirable for optimized sensitivity to a variety of FOD types. Either type of antenna element can be used in the MIMO antenna layout shown in FIG. 2; it is also possible to intersperse both types of antennas within the aperture to allow for single (HH or VV), dual (HH and VV), and/or crossed-polarization (HV and VH) radar polarimetry.

The number of beams steered by a frequency-scanned antenna of this type is approximately given by N=B*t, where B is the bandwidth of the frequency scan and t is the signal propagation time in the antenna. For an 8″ microstrip antenna on Duroid 3003, for instance, t=1.1 nanosecond. Given the scanning bandwidth of 3 GHz, then (transmit frequencies from 78 to 81 GHz), the antenna steers between 3 and 4 discrete beams.

After the radar data cube (range, velocity, azimuth) is computed for the first frequency chirp bandwidth (77.00-77.75 GHz), the chirp frequency is increased to a new band representing a slightly higher transmit beam elevation. In the preferred embodiment, a total of 6 elevation slices (about 2× oversampled) are desired, so the chirp frequencies are increased by 450 MHz at a time as follows:

| | |
|---|---|
| Elevation 1 (lowest) | 78.00-78.75 CHz |
| Elevation 2 | 78.45-79.20 GHz |
| Elevation 3 | 78.90-79.65 GHz |
| Elevation 4 | 79.35-80.10 GHz |
| Elevation 5 | 79.80-80.55 GHz |
| Elevation 6 (highest) | 80.25-81.00 GHz |

After this full cycle of chirp frequencies is complete, the fourth dimension of the radar data frame (elevation) is completed, yielding a data frame of 1024 ranges by 256 azimuths by 6 elevations by 128 velocities.

### Radar Update Rate

As described in the current embodiment, each transmit chirp is programmed to last 50 microseconds. Adding 10 microseconds tor oscillator settling and two-way travel time at the beginning and end of each chirp, the chirp repetition interval is 60 μs. A series of 100 successive chirps is used to affect code-division multiplexing and velocity processing, bringing the time to collect a 3-D radar data cube (range, azimuth, velocity) to 6 ms. Repeating this cycle at 6 different transmit beam elevations brings the total lime for collecting a 4-D radar frame (range, azimuth, elevation, velocity) to 36 ms. This equates to a radar frame update rate of 27.8 Hz. When the radar is mounted atop a truck moving at 60 mph (26.8 mps), each radar data frame is collected in a time duration corresponding to about 1 m of travel.

### Radar Sensitivity

Solid-state radar chips designed to support the automotive radar market typically transmit at power levels near 10 mW and receive with a noise figure of about 15 dB. Antenna gains for the synthetic array configuration shown in FIG. 2 are 20 dBi for transmit and 43 dBi for virtual receiver. Given these radar parameters, velocity processing on 6 ms signal samples allows for detection of FOD items at radar cross-section as small as −23 dBm² (similar to a AAA battery) on a smooth runway surface at a distance of 200 meters, with a single-frame signal-to-noise ratio (SNR) of 13 dB. Returns above this SNR threshold (about 5×10⁻¹⁶ W) are flagged as FOD detections, while lower returns are considered to be background clutter and/or noise, and are ignored. A Graphical User Interface, as shown in FIG. 5B, generates a stylized icon at the position corresponding to the range and azimuth angle at which FOD was detected, and overlays this on an airport map along with GPS coordinates of the detected debris.

### Preferred Embodiment with Gap Filling

The antenna configuration described above, shown pictorially in FIG. 2, leaves some central gaps in the phased array receive antenna as synthesized and shown FIG. 3. In almost all cases the detrimental effect of these gaps on radar detection performance is minimal and can be mitigated or even eliminated by well-known numerical gap-tilling routines employed as a part of digital beamforming. However, the presence of very large radar reflectors (for instance parked aircraft or hangar buildings) in close proximity to small debris objects can limit the radar's detection sensitivity by creating ghost target returns which may cloak the smaller true returns. Although other MIMO antenna designs are possible with fewer number of gaps in the synthesized virtual antenna array, the preferred embodiment was selected to allow larger spacing between physical Tx and Rx antenna elements in order to reduce their cross interference. The grating lobes issue can be mitigated at some extra expense of system cost and complexity. For example, the central gaps in the synthesized aperture can be filled by adding additional antenna elements to the preferred embodiment layout such as three transmitter elements and three receiver elements to the preferred antenna embodiment, as shown in FIG. 7, adds all of the missing central array baselines and thus fills all of the central gaps completely. The result is that the grating lobes shown in antenna patterns FIG. 5B and FIG. 5D practically disappear, leaving the more favorable patterns shown in FIG. 5A and 5C. As compared to the original 28 elements (12 transmit and 16 receive) in the prototype embodiment (FIG. 2), which generate 192 unique virtual receiver elements in the synthesized phased array (FIG. 3), the additional 6 elements add only 9 new virtual receiver elements, but these can be more effective than numerical gap-filling techniques for eliminating ghost returns when the dynamic range of target returns is very high.

### Reduction of 3D Data Cube and to 2D (Range and Azimuth)

The radar collects 3D data cube that includes 1024 data samples within each MMW frequency chirp, 128 zero padded data samples sets one per each chirp and all 1024×128 of the above data point arranged into 256 virtual receiver channel sets (partly zero padded and some zero by design), all data is sized for FFT processing.

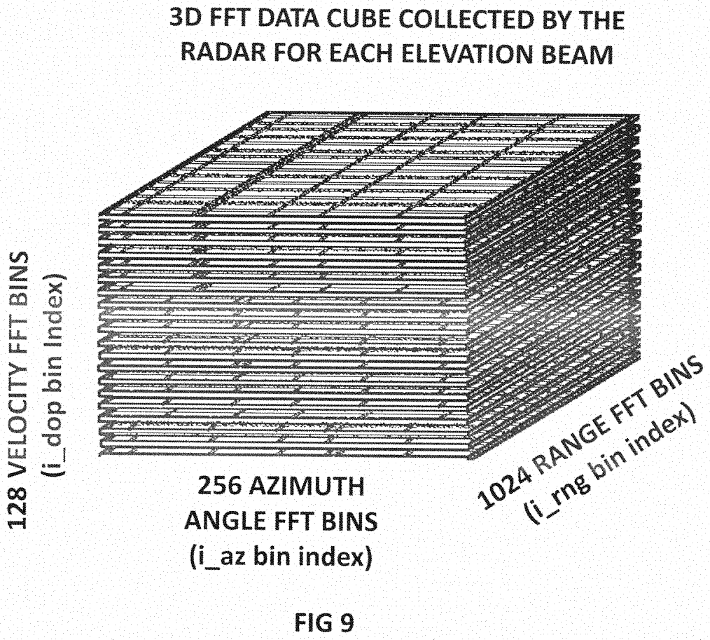

The radar processor performs FFTs in all three dimensions, producing a 3D FFT data cube including 1024 range data bins, 128 Doppler frequency (speed) data bins and 256 azimuth (AZ) beam angle data bins, which is illustrated in FIG. 9

Because preferred embodiment of the radar is concerned only of the targets that stationary relative to the ground, the 3D FFT data cube can be reduced to a 2D FFT planar data set representing stationary target on the ground in the AZ and range domain.

The maximum unambiguous relative velocity that can be measured by the radar is chat for which the phase of the return signal, from a target directly in front of the radar, advances by one full rotation during the chirp repetition interval. At this speed the radar moves by one-half wavelength during the repetition interval such that the two-way distance is reduced by one full wavelength. For instance, if the target is stationary and the radar chirp repetition interval is 100 ms, a radar operating at 80 GHz can move at a speed of up to 18.7 meters per second, or equivalently 41.9 miles per hour, in the direction of the target without creating measurement ambiguity. Doppler radar processing divides this maximum velocity into a number of velocity bins given by the number of successive radar chirps that are included in the processing set. For instance, if a set of 100 radar chirps at 100 ms repetition interval is included in the radar's Doppler transform, the Doppler velocity resolution becomes 41.9/100=0.419 miles per hour.

For purposes of Foreign Object Debris (FOD) detection from a truck-mounted radar, it is assumed that the radar is moving in the boresight direction of the antenna and the FOD is stationary. In this case it is possible to relate relative target velocities (corresponding to Doppler frequencies) to a discrete truck driving speed (vtruck), using the relation

$$vDoppler = 2 \frac{vtruck}{C} * cos θ ,$$

where c—is the speed of light and θ is the angle to the target relative to velocity vector of the radar.

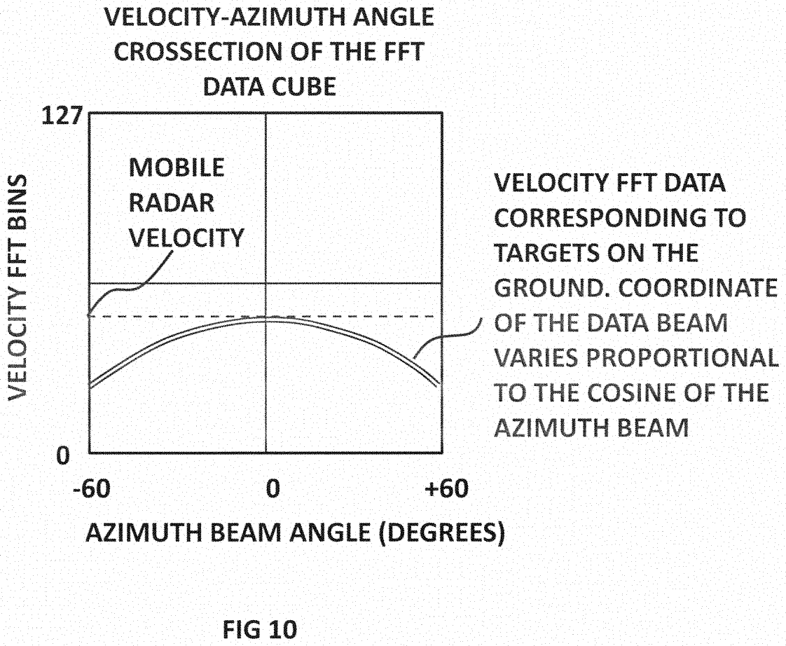

FIG. 10 illustrate relative position of the data corresponding to the targets on the ground in AZ-Doppler velocity cross-section of the cube for each given range bin. The map of the bins stationary targets is a line of bins having cosine shape with maximum at zero azimuth angle of the AZ antenna beam where detected Doppler frequency value is the largest.

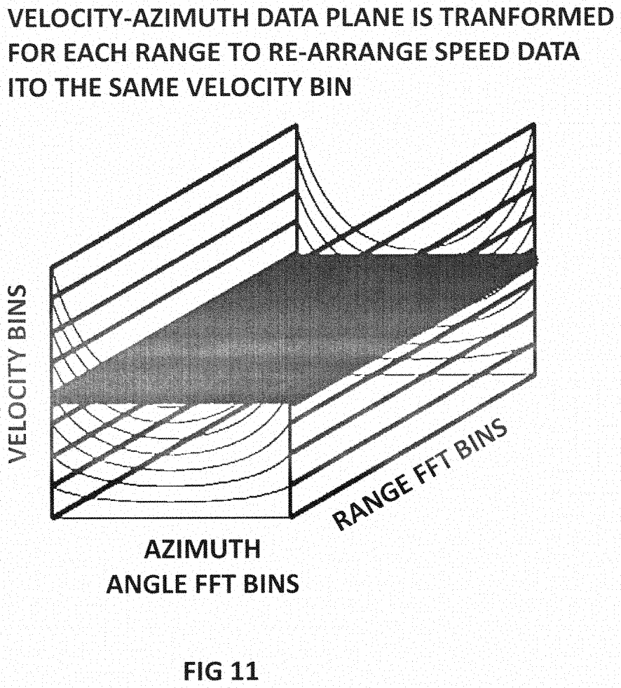

Since the radar data cube is already separated into discrete Doppler frequency (velocity) and azimuth angle bins, the cube can be easily reconfigured from (range, azimuth, Doppler frequency/velocity) planes to (range, azimuth, truck velocity) by re-scaling the Doppler bin axis to inversely proportional scale of the cosine of the beam AZ angle as shown in FIG. 11. As a result, this warped 3D data “cube” becomes populated with the stationary targets return signals on one plane, and all other “phantom” targets are located elsewhere within the “cube”. Since the phantom targets are spread throughout the cube and the stationary targets all lie within a single plane, the data processor can accurately determine the truck velocity automatically by locating the velocity plane with the maximum integrated over ail Doppler bins signal power. Once the plane location that contains stationary target responses is determined, all other data can be discarded, thus reducing the 3D data cube set to a 2D AZ and range planar data set.

An alternate approach to reduce the 3D data cube to 2D is to compute Fourier transforms for the data corresponding to the targets on the ground. It will require a separate measurement of the vehicle velocity using GPS, a stand alone Doppler radar or by other means.

### Radar Calibration and Automatic Self Calibration

Radar operation under nominal design condition is critical for its optimum performance. The preferred embodiment system requires periodical calibration to correct deviations from the nominal design settings. The most important calibration factors are strength and the phase of the receive signals. At the radar circuit level the strength of the signals is determined by the chip transmit and receive characteristics, which are maintained within nominal range by the chip circuitry. It is controlled and automatically operated by embedded codes provided by the chip vendor. The phase of the receive signals also depends on the internal characteristics of the chip, but, in addition, on the printed circuit board layout that includes antennas and the antenna feed lines. Ideally the phase of the transmit and receive signals as they pass through the antennas will be perfectly equal, which ensures best possible beam forming performance of the antenna array. In practice it is difficult to achieve and can only be maintained with some degree of accuracy. The purpose of the radar calibration and, specifically, its phase calibration is to keep phase alignment of all virtual receive channels close to the nominal design requirements.

The calibration includes three components: firstly, calibration of internal chip characteristics using controls provided by the chip vendor, secondly, initial calibration of the radar antenna phases using a single or several strong point targets such as corner retroreflectors and, thirdly, periodical self-calibration to correct for deviations from initial calibration settings. The self-calibration component relics on signals from pre-selected sufficiently strong targets within radar field of view and range as installing artificial reference targets, such as cubes, may not be possible

Phase errors in the virtual antenna array channels have the dominant impact on the degradation of the azimuth beam shape of the radar, which may result in the loss of the antenna gain, high grating lobes and unwanted cross-interference of signals arriving from different directions.

The preferred embodiment of the radar maintains nominal phase characteristics of the radar chips by periodically running calibration procedures provided by the vendor. Initial calibration of the radar is performed either at the factory or at the installation site by measuring signals from at least one strong reference point target tor both the target and the radar in static positions.

### Initial Calibration of the Radar

A point target with high Radar Cross Section (RCS) value is installed in the far field of the static antenna. Complex range FFT data is collected for all virtual antenna channels at zero velocity Doppler frequency FFT bin. The phase Phase_{i_vr} of the signals relative to each is measured and complex calibration Zcal_{i_vr} factors are computed as follows:

Zcal_{i_vr}=exp(j*Phase_{i_vr}), (Eq.1)

where i_vr is the virtual array channel index and j is imaginary unit.

The calibration factors are then applied to complex FFT range and virtual antenna channel data to cancel off the phase inequality in the antenna array and residual errors in the electronic circuits. Given the 3D cube complex dataZ3D_{i_rng,i_dop,i_vr}, where (i_rng, i_dop and i_vr represent indices of the range FFT, Doppler/velocity FFT bins and virtual receivers numbers, sec FIG. 9.). the calibrated cube data Z3D_{i_rng,i_dop,i_vr} is computed as shown in the equation (Eq.2):

$$( Eq . 2 )$$

$$Z 3 {Dcal}_{i\_rng , i\_dop , i\_vr} = \frac{\sqrt[2]{{PWR}_{i\_rng}} * exp ( j * {Phase}_{i\_rng , i\_dop , i\_vr} )}{{Zcal}_{i\_vr}} ,$$

where PWR_{i_rng} is the average power over all receive channels at range bin i_rng and Phase_{i_rng,i_dop,i_vr} is the phase of complex cube dataZ3D_{i_rng,i_dop,i_vr}.

The calibrated cube data given by equation (Eq.2) intentionally reduces the amplitudes of individual vimial receiver channel signals to a constant in order to eliminate variations in their sensitivity.

### Self-Calibration of the Radar

Self-calibration of radar requires the truth data that can be compared with the data measured by the radar. The truth data is provided by measuring angular location of several sufficiently strong natural and/or artificially created reference targets within FOV and the range of the radar. For each reference target the expected (truth) phase distribution across the virtual antenna array channels can be readily calculated using the channel coordinates on the antenna board. For a given reference/truth signal the mismatch signal values for each virtual receiver can be computed as follows:

ERR_{i_vr}=exp(j*Phase_{Rtg,i}_{_{dop}}_{=0,i_vr})*exp(−j*TruePhase_{i_vr}), (Eq.3)

where Phase_{Rtg,i}_{_{dop}}_{=0,i_vr} measured phase of the range and Doppler FFT data of virtual receivers for the reference target located at range Rtg bin and zero Dozier bin (as both the radar and the target are stationary during calibration).

$${TrudPhase}_{i\_vr} = 2 π * \frac{{X}_{i\_vr}}{λ} sin ( θ trg ) \qquad ( Eq . 4 )$$

is the true expected phase of selected reference target, where X_{i_vr} is the coordinate of the virtual receiver in the array, λ is the MMW wave length of the Rx signals and θtrg is the angle to the reference target relative to the boresight of the antenna.

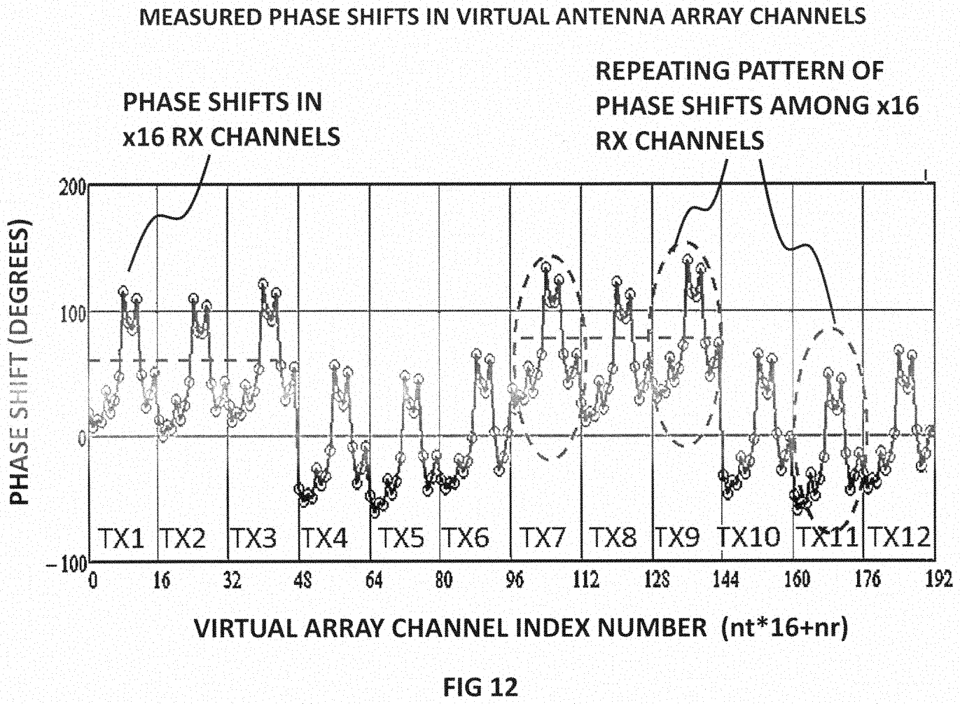

The phase variations in the virtual receivers of the antenna are due to the phase shifts in the x12 Tx and x16 Kx channels and the shift may drift over time after initial calibration. Because signals in the virtual receivers are produced by combining pairs of actual transmit and receive signals the phase drift in the individual virtual Rx channels are not independent, but are a combination of the drift in the corresponding actual/physical Tx and Rx radar chip channels. This is illustrated in FIG. 12. The data shows repeating patterns of the x16 Rx channel phase shifts on top of separate phase shifts of each Tx channel. Therefore Equations (Eq.3) can be re-written in the following form, where virtual receiver index i_vr, is replaced with the corresponding to actual Tx and Rx channel pair of indices nt and nr:

ERR_{nt,nr=}exp(j*Phase_{Rtg,i}_{_{dop}}_{=0,nt,nr})*exp(−j*TruePhase_{nt,nr}) (Eq.5)

As explained above the phase drift in all channels can be corrected by introducing x12 and x16 phase correction factors combined in pairs for any given virtual receiver. A set of x28 [{aₙₜ},{aₙᵣ}:nt 1 . . . 12, nt=1 . . . 16] the phase correction factors inserted into Eq.5 will define phase mismatch variables (VAR) that can be processed to minimize the drift errors:

VAR_{nt,nr=}arg(ERR_{nt,nr}*exp(j*(aₙₜ+aₙᵣ)), (Eq.6)

where arg( ) is a C++ program library function for computing the phase of complex value variables.

The sum of squared VAR variables representing cumulative errors in all virtual receivers can be minimized using standard optimization routines readily available in C++, Python, Matlab and oilier computer language program libraries Once the {aₙₜ},{aₙᵣ} correction phases are evaluated, the updated calibration factors shall be computed as shown in (Eq.7). where i_vr indices again replaced with corresponding nt,nr indices, and the {aₙₜ},{aₙᵣ} corrections are the ones found by optimization:

NewZ3Dcalᵢ_{_{rng}}_{,i}_{_{dop}}_{, nt,nr}Z3Dcalᵢ_{_{rng}}_{,i}_{_{dop}}_{,nt,nr}*exp(j*(aₙₜ+aₙᵣ)) (Eq.7)

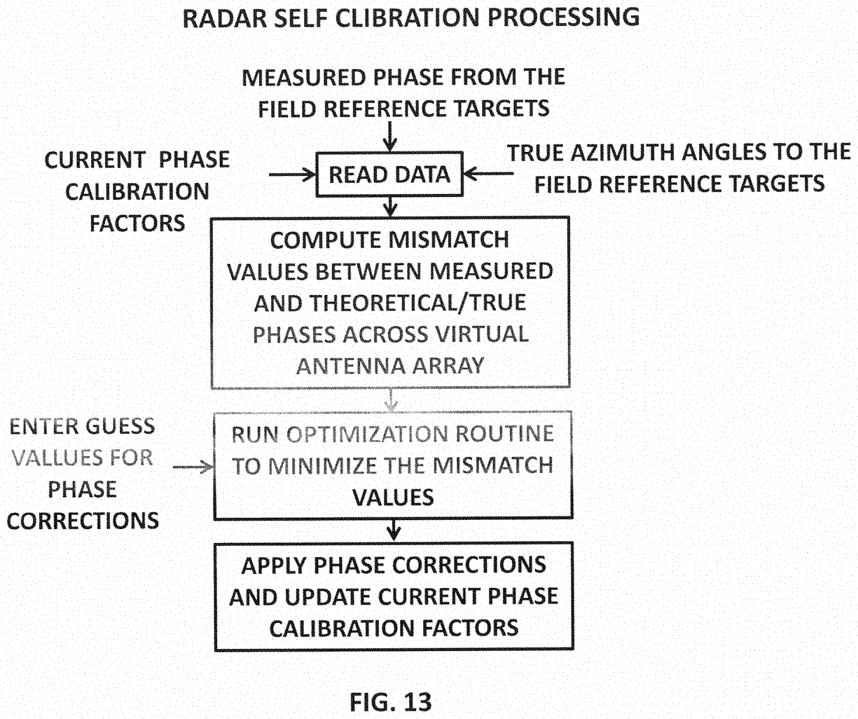

The above described self-calibration procedure for individual reference targets is illustrated in the block diagram (FIG. 13). Using multiple reference targets allows improvement of the self-calibration accuracy either by averaging the results obtained for different targets, or by co-processing of the phase errors for different reference targets, such as minimizing the phase variance over all receivers and all reference targets within the same optimization run.

### Fixed Radar Installations

The preferred FOD detection radar embodiment as described envisions the radar mounted on a vehicle and transported across airport surfaces. However, there is a related class of FOD detection systems for which the sensors are mounted at fixed positions in the airport environs, for instance on towers located at spatial intervals alongside a runway or taxiway. This represents a special case for the generalized radar described in the preferred embodiment; for this special case no velocity measurement is required. Stationary FOD items show a zero closing velocity relative to fixed radar, thus only the “zero-Doppler”, or first component of the velocity Fourier Transform as described, is earned through to beamforming and threshold processing for FOD detection.

No hardware modification and no other firmware modifications are needed in order to use the generalized radar in a stationary installation. However, eliminating the need for velocity processing also eliminates requirements tor shorter intervals between successive chirps, and by extension the need for transmitting out of all transmitting antenna elements simultaneously. This, in turn, eliminates the need for orthogonal transmit codes; i.e. when the transmitters are activated one at a time sequentially, the receiver signals collected at any given time are unique to a single transmitter and therefore need no decoding. In addition, the return signals from a fixed radar can be integrated for increased duration (compared to 16 ms in the preferred embodiment), thereby increasing the radar's sensitivity threshold and equivalently the maximum detection range for a given size of object.

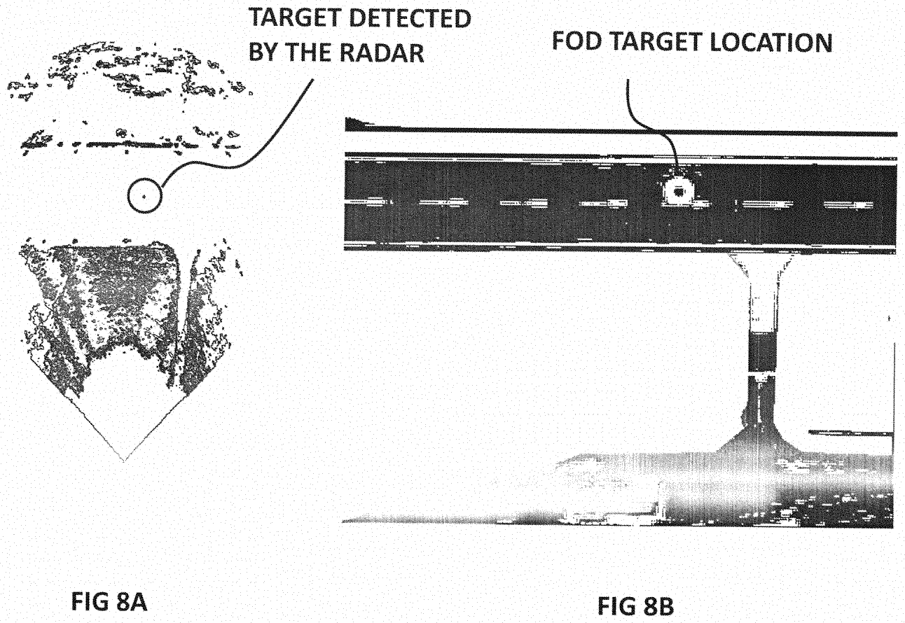

FIG. 8A shows actual radar data for a prototype of the preferred embodiment in either fixed or mobile case installation. FIG. 8B shows the Graphical User Interface, which displays an icon representing the presence of a debris item detected at the location indicated on an airport map, along with derailed information (GPS location, intensity, and a visible photograph taken from a pan/tip/zoom camera directed by the radar system).

### Reduction to Practice of the Preferred Embodiment

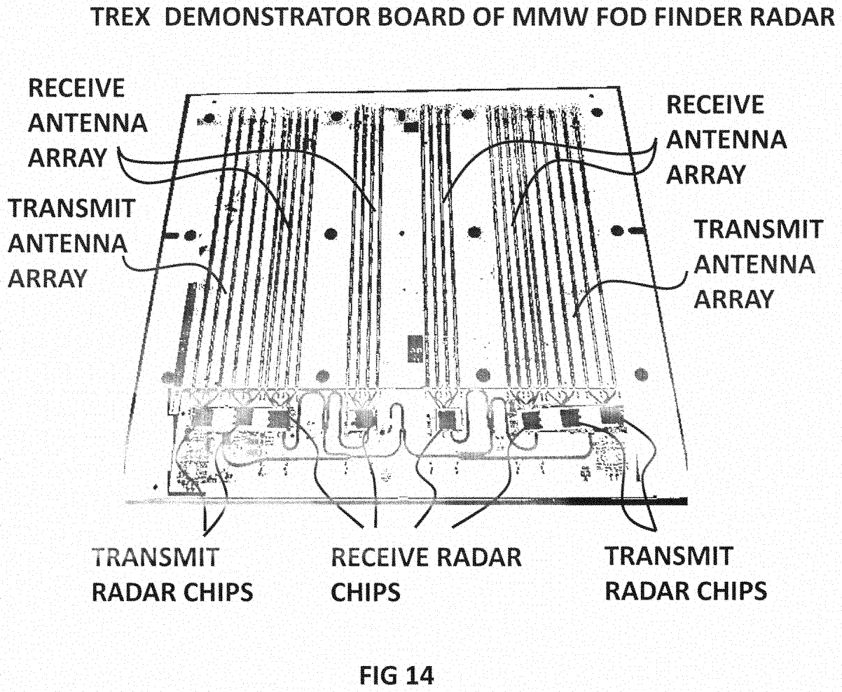

Over past several years MMW integrated component vendors, such as Infineon Technologies AG. Texas Instruments (TI) Corp., Analog Devices Corp. and others, have produced highly integrated slate of the art circuits for FMCW automotive radar application. The most advances AWR series single chip radar from Texas Instruments not only incorporates three transmit and four receive channels that are synchronized to operate simultaneously, but also includes signal modulation capabilities, digital output of the receive signals and digital processing processor on the same chip. The preferred embodiment demonstrator of the radar developed by Trex incorporates several of the TI chips combined into a nearly perfectly synchronized multi-chip FMCW radar system (FIG. 14).

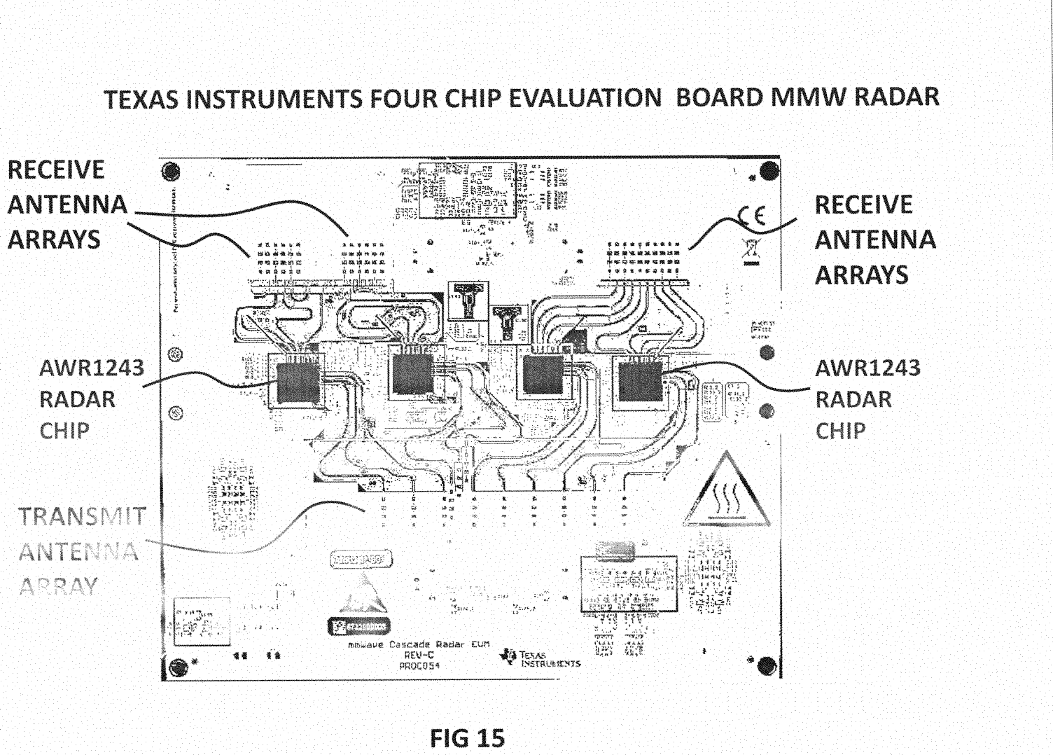

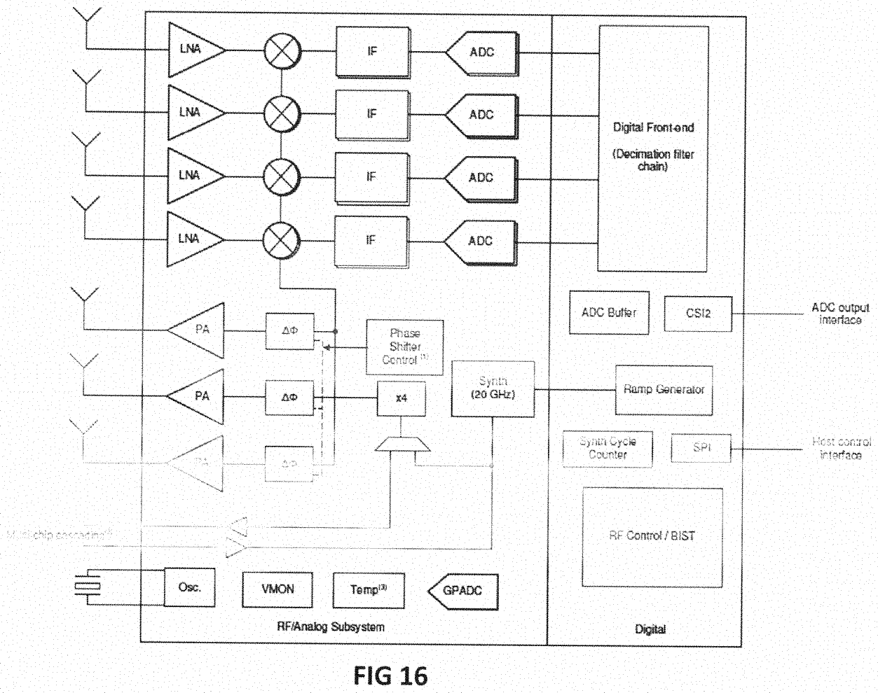

The engineering design of the preferred embodiment demonstrator was based on the product information and recommendations provided by the Tl. It also incorporates design principles described by TI for the four-chip MMWCAS-RF-EVM-swru553a development board which is current Commercial-Off-The-Shelf (COTS) product offered by TI (FIG. 15).

The principal differences between Trex preferred embodiment and the designs suggested by the TI are listed below:

Trex has developed a specialized antenna optimized for detection of very small stationary FOD objects on the ground, whereas TI radar use basic small antenna array, which is only adequate to detect very large targets, such as cars;

The preferred embodiment signal processing algorithms are trained to detect only targets that are static relative to the ground, the TI demo board was designed to detect moving ears.

The preferred embodiment signal processing maximizes sensitivity of the radar in order to detect FOD objects with the RCS as small as −20 dBsm and minimizing the interference from large targets (a typical car target RCS is in the +20 dBsm to +40 dBsm);

The preferred embodiment incorporates an algorithm to perform much more accurate self-calibration using field targets, as compared to the TI embedded in the chip self-calibration options.

### Variations

Although preferred embodiments of the present invention have been described in detail for the purpose of identifying FOD on airport facilities, especially airport runways, the teaching of this application would be extremely useful in many other applications, such short range detection and monitoring of ground vehicles, ships, boats, airborne objects, such as drones, humans and animals. Therefore, the scope of the present invention should be determined by the appended claims and their legal equivalence.

We claim:

1. A low-cost, light weight frequency-modulated continuous wave millimeter-wave radar system comprising:
A) a frequency scanned millimeter wave radar adapted to produce millimeter wave radiation scanned over a frequency range defining a first end of the frequency range to a second cud of the frequency range,
B) a MIMO millimeter wave antenna system adapted to transmit millimeter wave radiation to a field of view and to receive millimeter wave reflections from objects located in the field of view defining transmit beams and a receive beams, said MIMO millimeter wave antenna comprising u plurality of transmitter channels and a plurality of receive channels mated to discrete antenna elements to permit digital aperture synthesis so as to produce transmitter—receiver pairs at unique sparing intervals in order to permit determination of directions of arrival of millimeter wave radiation reflected from the objects in the field of view,
C) electronics adapted to modulate the millimeter wave radiation to produce a linear or approximately linear chirped transmit radar beam from one end of the frequency range to the other end operating frequency range,
D) at least two electronic mixers adapted to mix transmit beams with receive beams in order to directly measure a difference frequency permitting unique determinations of distances to reflecting object in the field of view.

2. The radar system as in claim 1 wherein the MIMO antenna system also comprises electronics adapted to modulate the transmit beam to transmit successive chirp sequences from each of the separate transmit channels with a unique code in the form of bi-phase modulation.

3. The radar system as in claim 2 wherein the codes are orthogonal pseudo random noise codes.

4. The radar system as in claim 3 wherein the orthogonal pseudo random noise codes are APAS codes.

5. The radar system as in claim 1 wherein the field of view is at least 60degrees in the azimuth direction and the vertical field of view is at least 15 degrees.

6 The radar system as in claim 1 wherein the first end of the frequency range is from 77 GHz and the second end of the frequency range is 81 GHz.

7. The radar system as in claim 1 wherein the radar system is designed for use on military equipment to permit operation in degraded visual environments

8. The radar system as in claim 1 wherein the radar system is designed for use on passenger cars and trucks.

9. The radar system as in claim 1 wherein radar front ends are provided CMOS integrated circuits at least one integrated circuit board,

10. The radar system as in claim 1 wherein radar front ends are provided on a plurality of Texas Instrument AWR 1243 sensors.
